(19) United States
(12) Patent Application Publication
(10) Pub. No.: US 2025/0056209 A1
(43) Pub. Date: Feb. 13, 2025

(54) LOCATION SESSION RECORD ENRICHMENT USING ACCESS AND MOBILITY MANAGEMENT FUNCTION PROBES

(71) Applicant: T-MOBILE INNOVATIONS LLC, Overland Park, KS (US)

(72) Inventors: Evstratios James KOUTROULIS, Seattle, WA (US); Raymond Weimin WU, Newcastle, WA (US); Darren Patrick HUSTING, Bellevue, WA (US); Vikas RANJAN, Bellevue, WA (US); Anandajothi MUTTAYANE, Renton, WA (US)

(21) Appl. No.: 18/233,175

(22) Filed: Aug. 11, 2023

(51) Int. Cl. H04W 8/24; H04W 24/08

(52) U.S. Cl. CPC H04W 8/24; H04W 24/08

(57) ABSTRACT

According to aspects herein, methods and systems for enriching location session record data are provided. More particularly, missing data of the location session record, such as an IMSI or MSISDN, is enriched with data from AMF probes. Initially, a location session record (LSR) dataset is received from an LSR probe. At least a portion of data from an access and mobility management function (AMF) dataset is compared to at least a portion of data from an LSR dataset to identify a match between a record in the AMF dataset and a corresponding record in the LSR dataset. Upon identifying the match, the corresponding record in the LSR dataset is enriched with IMSI or MSISDN from the record in the AMF dataset.

### SUMMARY

Embodiments of the technology described herein are directed to, among other things, systems and methods for enriching location session record data. More particularly, missing data from the location session record, such as an International Mobile Subscriber Identity (IMSI) or Mobile Station Integrated Services Digital Network (MSISDN), is enriched with data from access and mobility management function (AMF) probes. Initially, a location session record (LSR) dataset is received from an LSR probe. At least a portion of data from an access and mobility management function (AMF) dataset is compared to at least a portion of data from an LSR dataset to identify a match between a record in the AMF dataset and a corresponding record in the LSR dataset. Upon identifying the match, the corresponding record in the LSR dataset is enriched with IMSI or MSISDN from the record in the AMF dataset.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Implementations of the present disclosure are described in detail below with reference to the attached drawing figures, wherein:

FIG. 1 illustrates a diagram of an exemplary network environment in which implementations of the present disclosure may be employed;

FIG. 2 depicts an example of enriching a corresponding record in an LSR dataset with IMSI or MSISDN from the record in the AMF dataset, in accordance with aspects herein;

FIG. 3 is a flow diagram of an example method for enriching location session record data, in accordance with some aspects of the technology described herein; and

FIG. 4 depicts an example computing environment suitable for use in implementation of the present disclosure.

### DETAILED DESCRIPTION

The subject matter of embodiments of the invention is described with specificity herein to meet statutory requirements. However, the description itself is not intended to limit the scope of this patent. Rather, it is contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
BRS Broadband Radio Service
CD-ROM Compact Disk Read Only Memory
CDMA Code Division Multiple Access
EIRP Equivalent Isotropically Radiated Power eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MD Mobile Device
MIMO Multiple-Input Multiple-Output
mMIMO Massive Multiple-Input Multiple-Output
MMU Massive Multiple-Input Multiple-Output Unit
NEXRAD Next-Generation Radar
NR New Radio
NSA Nonstandalone
OOBE Out-of-Band-Emission
PC Personal Computer
PCS Personal Communications Service
PDA Personal Digital Assistant
RAM Random Access Memory
RAT Radio Access Technology
RET Remote Electrical Tilt
RF Radio-Frequency
RFI Radio-Frequency Interference
R/N Relay Node
RNR Reverse Noise Rise
ROM Read Only Memory
RRU Remote Radio Unit
RSRP Reference Transmission Receive Power
RSRQ Reference Transmission Receive Quality
RSSI Received Transmission Strength Indicator
SA Standalone
SINR Signal-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. A definition of such terms can be found in, for example, Newton's Telecom Dictionary by H. Newton, 31st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the technology may take the form of, among other things: a method, system, or set of instructions embodied on one or more computer-readable media. Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include but are not limited to information-delivery media,

RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point.

Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB or a New Radio (NR) connection). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point.

Location session record datasets normally have a low device level field correlation in individual records. Records without device level fields call into question the reliability and quality of the dataset itself. LSR 5G SA subscriber level data can be used by radio engineers, customer care, enterprise level tools like the network experience (NEX) score and for 5G band deployment.

In aspects herein, an enrichment process utilizes a separate dataset, PCMD (Per Call Measurement Data) AMF (Access and Mobility Management Function), to add missing IMSI and MSISDN to the LSR dataset. To enrich the 5G SA LSR dataset, the Temporary Mobile Subscriber Identity (m-TMSI), individual cell name, and time stamp is taken from AMF probes. The TMSI is significant only on a local level so the individual cell and timestamp are taken to verify the link between the 5G SA LSR probes and the AMF probes. If both the LSR and the AMF probes provide the same cell, timestamp, and TMSI, then a missing IMSI can be filled in for the 5G SA LSRs. Additionally, the MSISDN can also be enriched through a similar process.

The present disclosure is directed to systems, methods, and computer readable media for enriching location session record data. More particularly, missing data of the location session record, such as an IMSI or MSISDN, is enriched with data from AMF probes. Initially, a location session record (LSR) dataset is received from an LSR probe. At least a portion of data from an access and mobility management function (AMF) dataset is compared to at least a portion of data from an LSR dataset to identify a match between a record in the AMF dataset and a corresponding record in the LSR dataset. Upon identifying the match, the corresponding record in the LSR dataset is enriched with IMSI or MSISDN from the record in the AMF dataset.

According to aspects of the technology described herein, a method for enriching location session record data is provided. The method comprises receiving a location session record (LSR) dataset from an LSR probe corresponding to a network. The method also comprises comparing at least a portion of data from an access and mobility management function (AMF) dataset to at least a portion of data from an LSR dataset. The method further comprises upon identifying a match between a record in the AMF dataset and a corresponding record in the LSR dataset, enriching the corresponding record in the LSR dataset with IMSI or MSISDN from the record in the AMF dataset.

According to further aspects of the technology described herein, one or more computer-readable media having computer-executable instructions embodied thereon that, when executed by at least one computing device, cause the computing device to perform operations for enriching location session record data is provided. The operations comprise receiving a location session record (LSR) dataset from an LSR probe corresponding to a network. The operations also comprise comparing at least a portion of data from an access and mobility management function (AMF) dataset to at least a portion of data from an LSR dataset. The operations further comprise upon identifying a match between a record in the AMF dataset and a corresponding record in the LSR dataset, enriching the corresponding record in the LSR dataset with IMSI or MSISDN from the record in the AMF dataset.

According to even further aspects of the technology described herein, a system for enriching location session record data is provided. The system comprises a UE. The system also comprises a node configured to wirelessly communicate with the UE and provide access to a network. The system also comprises an enrichment engine comprising: a location session record (LSR) probe that receives an LSR dataset corresponding to the network; and an access and mobility management function (AMF) probe that receives an AMF dataset corresponding to the network, wherein the enrichment engine compares at least a portion of data from the AMF dataset to at least a portion of data from the LSR dataset and, upon identifying a match between a record in the AMF dataset and a corresponding record in the LSR dataset, enriches the corresponding record in the LSR dataset with IMSI or MSISDN from the record in the AMF dataset.

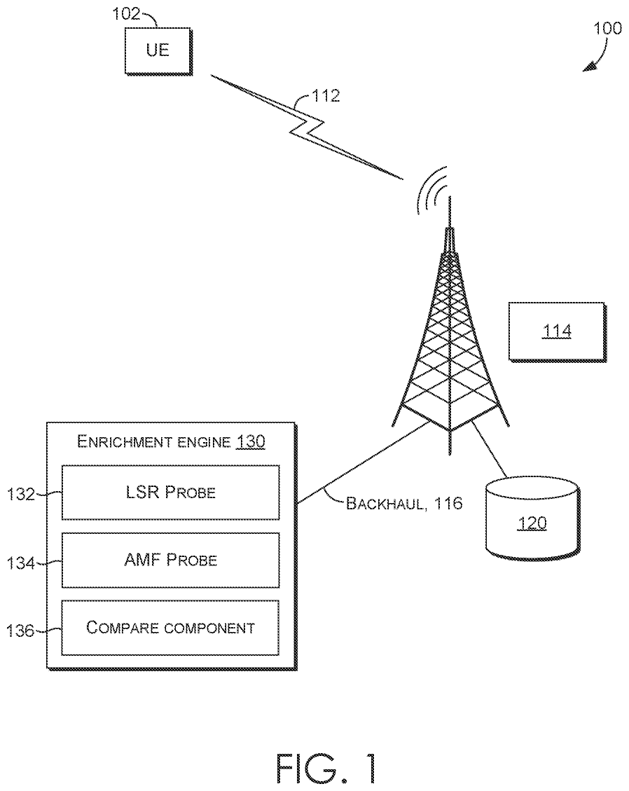

FIG. 1 depicts a wireless network environment incorporating a carrier aggregation system in which implementations of the present disclosure may be employed. Such a network environment is illustrated and designated generally as network environment 100. Network environment 100 is not to be interpreted as having any dependency or requirement relating to any one or combination of components illustrated.

Network environment 100 includes user equipment (UE) 102, access point 114 (which may be a cell site, base station, or the like), and one or more communication channels 112. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device) that communicates via wireless communications with the access point 214 in order to interact with a public or private network.

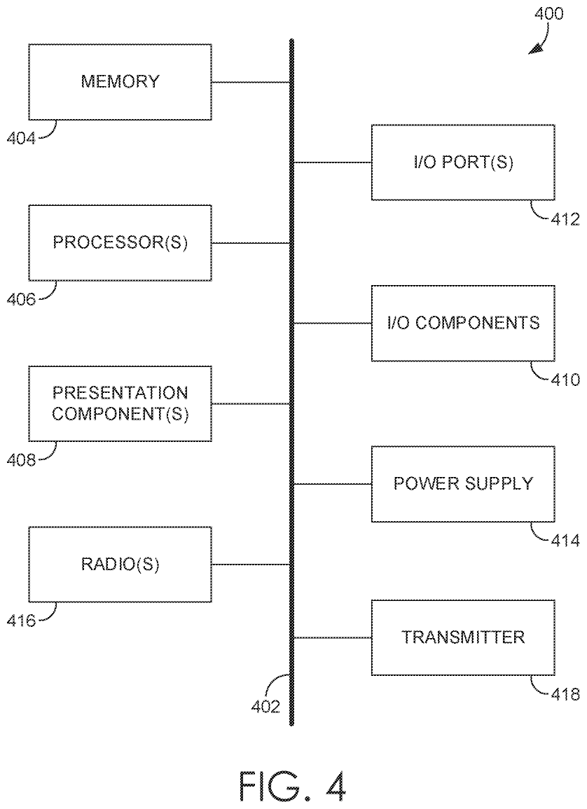

In some aspects, the UE 102 may correspond to computing device 400 in FIG. 4. Thus, a UE can include, for example, a display(s), a power source(s) (e.g., a battery), a data store(s), a speaker(s), memory, a buffer(s), a radio(s) and the like. In some implementations, for example, a UE 102 comprises a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, or any other type of network.

In some cases, UE 102 in network environment 100 can optionally utilize one or more communication channels 112 to communicate with other computing devices (e.g., a mobile device(s), a server(s), a personal computer(s), etc.) through access point 114. The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, NR, and the like) to user devices, such as UE 102. For example, the one or more communication channels may provide voice, SMS, and/or data services to UE 102, or corresponding users that are registered or subscribed to utilize the services provided by the telecommunications service provider. The one or more communication channels 112 can comprise, for example, a 1x circuit voice, a 3G network (e.g., CDMA, CDMA2000, WCDMA, GSM, UMTS), a 4G network (WiMAX, LTE, HSDPA), or a 5G network.

In some implementations, access point 114 is configured to communicate with a UE, such as UE 102, that are located within the geographic area, or cell, covered by radio antennas of access point 114. An access point 114 may include one or more base stations, base transmitter stations, radios, antennas, antenna arrays, power amplifiers, transmitters/receivers, digital signal processors, control electronics, GPS equipment, and the like. In particular, access point 114 may selectively communicate with the user devices using dynamic beamforming.

As shown, access point 114 is in communication with a network component 130 and at least a network database 120 via a backhaul channel 116. As the UE 102 communicates with the access point 114, access point 114 may collect and store data corresponding to the UE 102 at a network database 120. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the data stored in the network database 120 current. The data can include, for example, IMSI, MTMSI (M-Temporary Mobile Subscriber Identity), start time, cell information, MSISDN, uplink and downlink usage, geographic location, time of day, available networks, and the like.

The enrichment engine 130 generally enriches records in an LSR dataset with data from an AMF dataset. Although the network usage engine 130 is shown as a single component comprising the LSR probe 132, the AMF probe 134, and the compare component 136, it is also contemplated that each of the LSR probe 132, the AMF probe 134, and the compare component 136 may reside at different locations, be its own separate entities, and the like, within the home network carrier system, or as a component of UE 102.

The LSR probe 132 generally collects a location session record dataset corresponding to a network. The LSR dataset may include IMSI, MTMSI, start time, or cell.

The AMF probe 134 generally collects an AMF dataset. For example the AMF probe 134 may collect per call measurement data. The AMF dataset may include MTMSI, start time, cell, IMSI, or MSISDN.

The compare component 136 generally compares at least a portion of data from the AMF dataset to at least a portion of data from the LSR dataset to identify a match between a record in the AMF dataset and a corresponding record in the LSR dataset. Upon identifying a match, the compare component 136 enriches the corresponding record in the LSR dataset with IMSI or MSISN from the record in the AMF dataset.

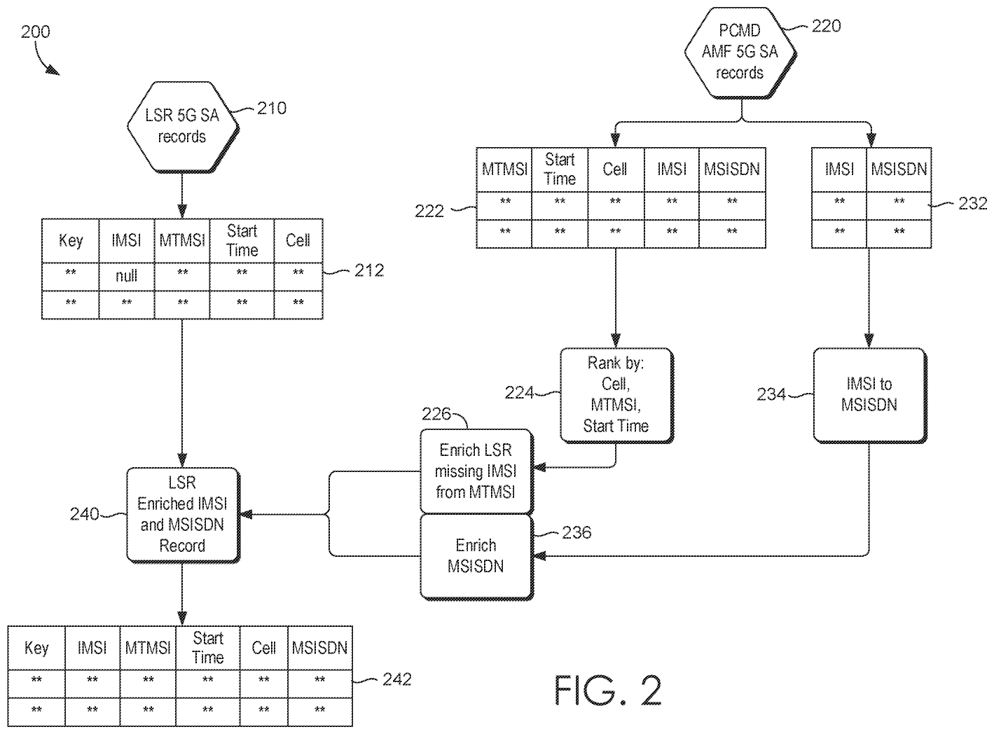

FIG. 2 illustrates depicts an example 200 of enriching a corresponding record in an LSR dataset with IMSI or MSISDN from the record in the AMF dataset, in accordance with aspects herein. As illustrated, an LSR probe collects LSR records 210. Similarly, an AMF probe collects AMF records 220. LSR record 212 is missing IMSI data. However, AMF record 222 and AMF record 232 is not missing the IMSI data. Component 224 of enrichment engine ranks data in AMF records 220 by cell, MTMSI, and start time (of the call). Component 226 of enrichment engine identifies the missing IMSI from the MTMSI and enriches the LSR record 212. In some aspects, AMF record 232 can be utilized by component 234 of enrichment engine to map IMSI data to missing MSISDN data. Component 236 of enrichment engine enriches 236 the LSR record 212 with the MSISDN data. The LSR record 212 is updated by component 240 of enrichment engine with the IMSI data and/or the MSIDN data.

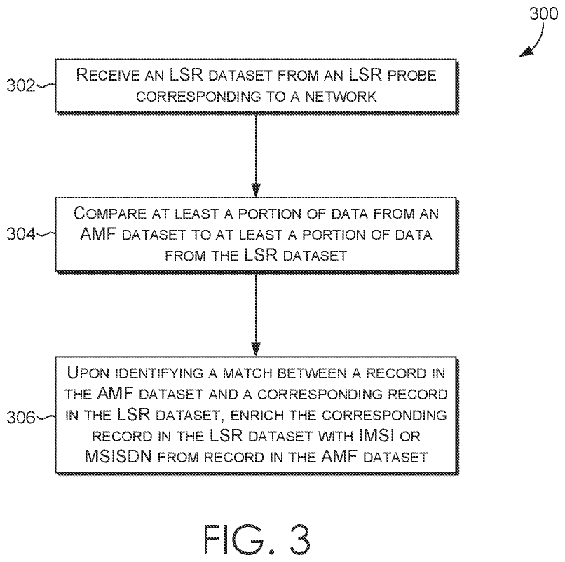

Referring to FIG. 3, a flow diagram is provided depicting a method 300 for enriching LSR data, in accordance with aspects of the present invention. Method 300 may be performed by any computing device (such as computing device described with respect to FIG. 4) with access to an enrichment engine (such as the one described with respect to FIG. 1) or by one or more components of the network environment described with respect to FIG. 1 (such as UE 102, access point 114, or enrichment engine 130).

Initially, at step 302, a location session record (LSR) dataset is received from an LSR probe corresponding to a network. At step 304, at least a portion of data from an access and mobility management function (AMF) dataset is compared to at least a portion of data from an LSR dataset to identify a match between a record in the AMF dataset and a corresponding record in the LSR dataset. In some aspects, the AMF dataset corresponds to call measurement data collected by an AMF probe. In some aspects, the portion of data corresponds to: a temporary mobile subscriber identity (m-TMSI), a cell name, and a time stamp.

At step 306, upon identifying the match, the corresponding record in the LSR dataset is enriched with IMSI or MSISDN from the record in the AMF dataset. Utilizing the enriched corresponding record in the LSR dataset, in some aspects, one or more key performance indicators are updated for a customer. In some aspects, utilizing the updated one or more key performance indicators for the customer, a network experience score is determined. In some aspects, a warrant for information associated with a customer may be received. Based on the warrant, the information associated with the customer may be provided. For clarity, the information is derived from the enriched corresponding record.

FIG. 4 depicts a diagram of an exemplary network environment in which implementations of the present disclosure may be employed. In FIG. 4, computing device 400 includes bus 402 that directly or indirectly couples the following devices: memory 404, one or more processors 406, one or more presentation components 408, input/output (I/O) ports 412, I/O components 410, radio 416, transmitter 418, and power supply 414. Bus 402 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component such as a display device to be one of I/O components 410. Also, processors, such as one or more processors 406, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. Memory 404 may be removable, nonremovable, or a combination thereof. Exemplary memory includes solid-state memory, hard drives, optical-disc drives, etc. Computing device 400 includes one or more processors 406 that read data from various entities such as bus 402, memory 404 or I/O components 410. One or more presentation components 408 present data indications to a person or other device. Exemplary one or more presentation components 408 include a display device, speaker, printing component, vibrating component, etc. I/O ports 412 allow computing device 400 to be logically coupled to other devices including I/O components 410, some of which may be built into computing device 400. Illustrative I/O components 410 include a microphone, joystick, game pad, satellite dish, scanner, printer, wireless device, etc.

The radio 416 represents one or more radios that facilitate communication with a wireless telecommunications network. While a single radio 416 is shown in FIG. 4, it is contemplated that there may be more than one radio 416 coupled to the bus 402. In aspects, the radio 416 utilizes a transmitter 418 to communicate with the wireless telecommunications network. It is expressly conceived that a computing device with more than one radio 416 could facilitate communication with the wireless telecommunications network via both the first transmitter 418 and an additional transmitters (e.g. a second transmitter). Illustrative wireless telecommunications technologies include CDMA, GPRS, TDMA, GSM, and the like. The radio 416 may additionally or alternatively facilitate other types of wireless communications including Wi-Fi, WiMAX, LTE, 3G, 4G, LTE, 5G, NR, VOLTE, or other VoIP communications. As can be appreciated, in various embodiments, radio 416 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for enriching location session record data, the method comprising:
receiving a location session record (LSR) dataset from an LSR probe corresponding to a network;
comparing at least a portion of data from an access and mobility management function (AMF) dataset to at least a portion of data from the LSR dataset; and
upon identifying a match between a record in the AMF dataset and a corresponding record in the LSR dataset, enriching the corresponding record in the LSR dataset with IMSI or MSISDN from the record in the AMF dataset.

2. The method of claim 1, wherein the AMF dataset corresponds to per call measurement data collected by an AMF probe.

3. The method of claim 1, wherein the portion of data corresponds to: a temporary mobile subscriber identity (m-TMSI), a cell name, and a time stamp.

4. The method of claim 1, further comprising, utilizing the enriched corresponding record in the LSR dataset, updating one or more key performance indicators for a customer corresponding to the enriched corresponding record.

5. The method of claim 4, further comprising, utilizing the updated one or more key performance indicators for the customer, determining a network experience score.

6. The method of claim 1, further comprising receiving a warrant for information associated with a customer.

7. The method of claim 6, further comprising, based on the warrant, providing the information associated with the customer, the information derived from the enriched corresponding record.

8. One or more computer-readable media having computer-executable instructions embodied thereon that, when executed by at least one computing device, cause the computing device to perform operations for enriching location session record data, the operations comprising:
receiving a location session record (LSR) dataset from an LSR probe corresponding to a network;
comparing at least a portion of data from an access and mobility management function (AMF) dataset to at least a portion of data from an LSR dataset; and
upon identifying a match between a record in the AMF dataset and a corresponding record in the LSR dataset, enriching the corresponding record in the LSR dataset with IMSI or MSISDN from the record in the AMF dataset.

9. The one or more computer-readable media of claim 8, wherein the AMF dataset corresponds to per call measurement data collected by an AMF probe.

10. The one or more computer-readable media of claim 8, wherein the portion of data corresponds to: a temporary mobile subscriber identity (m-TMSI), a cell name, and a time stamp.

11. The one or more computer-readable media of claim 8, further comprising, utilizing the enriched corresponding record in the LSR dataset, updating one or more key performance indicators for a customer corresponding to the enriched corresponding record.

12. The one or more computer-readable media of claim 11, further comprising, utilizing the updated one or more key performance indicators for the customer, determining a network experience score.

13. The one or more computer-readable media of claim 8, further comprising receiving a warrant for information associated with a customer.

14. The one or more computer-readable media of claim 13, further comprising, based on the warrant, providing the information associated with the customer, the information derived from the enriched corresponding record.

15. A system for enriching location session record data, the system comprising:
user equipment (UE);
a node configured to wirelessly communicate with the UE and provide access to a network; and
an enrichment engine comprising:
a location session record (LSR) probe configured to receive an LSR dataset corresponding to the network; and
an access and mobility management function (AMF) probe configured to receive an AMF dataset corresponding to the network, wherein the enrichment engine compares at least a portion of data from the AMF dataset to at least a portion of data from the LSR dataset and, upon identifying a match between a record in the AMF dataset and a corresponding record in the LSR dataset, enriches the corresponding record in the LSR dataset with IMSI or MSISDN from the record in the AMF dataset.

16. The system of claim 15, wherein the AMF dataset corresponds to per call measurement data collected by the AMF probe.

17. The system of claim 15, wherein the portion of data corresponds to: a temporary mobile subscriber identity (m-TMSI), a cell name, and a time stamp.

18. The system of claim 15, wherein the enriched corresponding record in the LSR dataset is utilized to update one or more key performance indicators for a customer corresponding to the enriched corresponding record.

19. The system of claim 18, wherein the updated one or more key performance indicators for the customer are utilized to determine a network experience score.

20. The system of claim 15, wherein the information associated with the customer and derived from the enriched corresponding record is provided based on a warrant for information associated with a customer.
